(19) United States
(12) Patent Application Publication
(10) Pub. No.: US 2008/0163634 A1
(43) Pub. Date: Jul. 10, 2008

(54) Air conditioning system for construction and agricultural vehicles

(75) Inventor: Kenichi Yoshii, Nagoya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 12/006,867

(22) Filed: Jan. 7, 2008

(30) Foreign Application Priority Data
Jan. 9, 2007 (JP) 2007-001283
Nov. 1, 2007 (JP) 2007-284951

(51) Int. Cl. B60H 1/32

(52) U.S. Cl. 62/244

(57) ABSTRACT

An air conditioning system for construction and agricultural vehicles is disclosed. A case includes an air-mix chamber into which blown air flows after passing through a cooling heat exchanger. The blown air that has flowed into the air-mix chamber flows out through a front face opening and a rear face opening. The front face opening and the rear face opening are arranged in such a manner that a first angle between the inflow direction in which the blown air flows into the air-mix chamber and a first outflow direction in which the blown air flows out from the front face opening is not smaller than a second angle between the inflow direction and a second outflow direction in which the blown air flows out from the rear face opening.

### BACKGROUND OF THE INVENTION

1. Technical Field of the Invention

This invention relates to an air conditioning system for construction and agricultural vehicles, which is applicable to construction vehicles such as a hydraulic shovel and agricultural vehicle such as a tractor.

2. Description of the Related Art

A conventional air conditioning system for vehicles includes an air-conditioning case having built therein a heat exchanger for exchanging heat with air blown into the cabin (see, for example, Japanese Unexamined Patent Publication No. 11-11135). In the air conditioning system for vehicles disclosed in Japanese Unexamined Patent Publication No. 11-11135, the air-conditioning case has a front face opening from which air-conditioning air flows out toward the upper half of the body of each of the front seat occupants and a rear face opening from which air-conditioning air flows out toward the upper half of the body of each of the rear seat occupants (see, for example, Japanese Unexamined Patent Publication No. 11-11135).

### SUMMARY OF THE INVENTION

In the air conditioning system described in Japanese Unexamined Patent Publication No. 11-11135 for use in construction vehicles such as a hydraulic shovel, the air-conditioning case is required to be arranged behind the cabin, and therefore, the size of the air-conditioning case along the longitudinal direction of the vehicle is limited. In the air-conditioning case, a blower unit with a blower mounted thereon and a heat exchanger unit with a heat exchanger mounted thereon are arranged in juxtaposition transversely of the vehicle. As a result, blown air passed through the heat exchanger flows in the transverse direction of the vehicle.

In the case where the heat exchanger unit is arranged on the right side of the blower unit in the air-conditioning case, for example, as shown in FIGS. 13A and 13B, blown air flowing into an air-mix chamber J31 through a heat exchanger J24 flows in the direction of arrow x. In the process, a foot opening J36 in an air-conditioning case J11 for ejecting air-conditioning air toward the lower half of the body of an occupant is opened forward, a front face opening J33 rightward, and a rear face opening J34 upward.

In order to improve the operability, the construction vehicle must have as large a cabin glass area as possible to secure a wide field of view. Therefore, the occupant is exposed to the direct heat of sunlight in the summer, for example. To overcome this disadvantage, a design is under study to improve the occupant's sensation of being cooled in the upper half part of his/her body.

The present inventor, as the result of studying the ratio of the air capacity between air blown out of front face opening J33 and air blown out of rear face opening J34, has found that the occupant's sensation of being cooled is improved in the case where the flow rate of air blown out of rear face opening J34 is not lower than the flow rate of air blown out of front face opening J33.

In the air-conditioning unit described above, the direction in which the blown air flows into an air-mix chamber J31 (the direction of arrow x in FIG. 13B) coincides with the direction in which the blown air flows out of front face opening J33 (the direction of arrow y in FIG. 13B), and therefore, it is necessary that the opening area of front face opening J33 be reduced to increase the flow rate of the air ejected from rear face opening J34 beyond the flow rate of the air ejected from front face opening J33.

In view of the fact that the direction in which the air is ejected from a foot opening J36 diagonally toward the front of the vehicle with respect to the direction in which the blown air flows into air-mix chamber J31, the area of foot opening J36 cannot be made large. Therefore, the workload on the blower has to be increased in order to increase the flow rate of the air ejected from rear face opening J34 in “face mode” for cooling the occupant's face beyond the flow rate of the air ejected from front face opening J33 while at the same time securing the air flow rate to the face and foot of the occupant. However, increasing the workload on the blower, poses the problems of an increased power consumption of the blower, a shortened life of the blower motor and an increased noise.

Further, the air-conditioning unit cannot have a large distance between an air inflow portion J200 of the heat exchanger unit by way of which the blown air flows in from the blower and the upstream surface of heat exchanger J24 in the air flow. This poses a serious problem of increased noise.

In view of the above-mentioned points, the object of this invention is to provide an air conditioning system for construction and agricultural vehicles capable of improving the occupant's sensation of being cooled an without increasing the workload on the blower.

In order to achieve the object described above, according to a first aspect of the invention, there is provided an air conditioning system for construction and agricultural vehicles, comprising a blower (19) for blowing air into a cabin, a case (11) through which the air blown by blower (19) flows, and a cooling heat exchanger (24) for cooling the blown air, wherein case (11) includes a chamber (31) into which the blown air flows after passing through cooling heat exchanger (24) and a first opening (33) and a second opening (34) from which the blown air that has flowed into chamber 31 flows out, wherein first opening (33) causes the air ejected toward the upper half of the body of an occupant from the front side of the occupant to flow out from chamber (31), and second opening (34) causes the air ejected from at least one of the rear and upper sides of the occupant toward the upper half of the body of the occupant to flow out of chamber (31), and wherein first opening (33) and second opening (34) are arranged in such a manner that a first angle (θ₁) between the inflow direction (b, l) in which the blown air flows into chamber (31) and the first outflow direction (f, p) in which the blown air flows out from first opening (33) is not less than a second angle (θ₂) between the inflow direction (b, l) and the second outflow direction (e, o) in which the blown air flows out of second opening (34) to make sure that the flow rate of the blown air flowing out of second opening (34) is higher than the flow rate of the blown air flowing out of first opening (33).

In case (11), the smaller the angle between the inflow direction in which the blown air flows into chamber (31) and the outflow directions in which the blown air flows out of an opening, the higher the flow rate of the blown air flowing out of the particular opening.

By setting the first angle (θ1) at not less than the second angle (θ2), the flow rate of the blown air flowing out of second opening (34) equal to or higher than the flow rate of the blown air flowing out of first opening (33) can be easily secured. Specifically, the flow rate of the air ejected from at least one of the rear and upper sides of the occupant equal to or higher than the flow rate of the air ejected from the front side of the occupant can be easily secured. Therefore, the occupant's sensation of being cooled can be improved without increasing the workload on blower (19).

The first angle (θ1) is defined as an angle formed between the inflow direction (b, 1) in which the blown air flows in and the first outflow direction (f, p) of the blown air, which angle is assumed to be 0° in the case where the inflow direction (b, 1) in which the blown air flows into chamber (31) is identical with the first outflow direction (f, p) in which the blown air flows out of first opening (33) and 180° in the case where the inflow direction (b, l) of the blown air and the first outflow direction (f, p) of the blown air are opposite to each other.

In a similar fashion, the second angle (θ2) is defined as an angle formed between the inflow direction (b, l) of the blown air and the second outflow direction (e, o) of the blown air, which angle is assumed to be 0° in the case where the inflow direction (b, l) in which the blown air flows into chamber (31) is identical with the second outflow direction (e, o) in which the blown air flows out of second opening (34), and 180° in the case where the inflow direction (b, l) of the blown air and the second outflow direction (e, o) of the blown air are opposite to each other.

Thus, the ranges in which the first angle (θ1) and the second angle (θ2) can assume are both 0° to 180°.

Also, in the air conditioning system for construction and agricultural vehicles having the feature described above, the first angle (θ1) and the second angle (θ2) may be equal to each other.

By doing so, the air capacity ratio between the blown air flowing out of first opening (33) and the blown air flowing out of second opening (34) can be easily adjusted as desired.

Also, in the air conditioning system for construction and agricultural vehicles having the feature described above, the first angle (θ1) and the second angle (θ2) may be 90°.

Also, in the air conditioning system for construction and agricultural vehicles having the feature described above, cooling heat exchanger (24) and chamber (31) may be arranged in that order from the rear of the vehicle, the inflow direction (b, l) may be forward, the first outflow direction (f, p) may be rightward and/or leftward from chamber (31), and the second outflow direction (e, o) may be upward and/or forward from chamber (31).

Also, in the air conditioning system for construction and agricultural vehicles having the feature described above, cooling heat exchanger (24) and chamber (31) may be arranged in that order in the upward direction, the inflow direction (b, l) may be upward, the first outflow direction (f, p) may be rightward and/or leftward from chamber (31), and the second outflow direction (e, o) may be upward and/or forward from chamber (31).

Also, in the air conditioning system for construction and agricultural vehicles having the feature described above, case (11) may include an air capacity adjusting means (38) for adjusting the air capacity ratio between the blown air flowing out of first opening (33) and the blown air flowing out of second opening (34).

By doing so, the air capacity ratio between the blown air flowing out of first opening (33) and the blown air flowing out of second opening (34) can be easily adjusted. Specifically, the flow rate of the blown air flowing out of first opening (33) can be increased beyond the flow rate of the blown air flowing out of second opening (34) whenever required.

Also, in the air conditioning system for construction and agricultural vehicles having the feature described above, case (11) includes a heating heat exchanger (25) for heating the blown air after being passed trough cooling heat exchanger (24) and a cool air bypass (27) in which the cool air flows bypassing heating heat exchanger (25), and the chamber may be an air-mix chamber (31) for mixing the cool air passing through cool air bypass (27) and the warm air passing through heating heat exchanger (25).

In order to achieve the above-mentioned object, according to a second aspect of the invention, there is provided an air conditioning system for construction and agricultural vehicles, wherein case (11) includes chamber (31) into which the blown air passed through cooling heat exchanger (24) flows and first opening (33) and second opening (34) from which the blown air that has flowed into chamber (31) flows out, wherein first opening (33) is connected with a first duct (51) bent and extended forward after extending rightward or leftward for ejecting the blown air from the front of the occupant toward the upper half part of his/her body, wherein second opening (34) is connected with a second duct (52) extended upward for ejecting the blown air at least one of the rear and upper sides of the occupant toward the upper half part of his/her body, wherein cooling heat exchanger (24) and chamber (31) are arranged in that order upward, and wherein first opening (33) is arranged rightward and/or leftward of case (11) and second opening (34) upward and/or forward of case (11).

As described above, in the case where first opening (33) connected with first duct (51) bent and extended forward after being extended rightward or leftward is arranged rightward and/or leftward of case (11), the air flow is required to be curved at least once in first duct (51). In the case where second opening (34) connected with second duct (52) extending upward is arranged upward and/or forward of case (11), on the other hand, the air flow is not required to be curved to a large measure in second duct (52).

As a result, the air resistance of second duct (52) is reduced below the air resistance of first duct (51), and therefore, a higher flow rate of the air ejected from at least one of the rear and upper sides of the occupant than the flow rate of the air ejected from the front side of the occupant can be easily secured. Thus, the occupant's sensation of being cooled can be improved without increasing the work done by blower (19).

According to a third aspect of this invention, there is provided an air conditioning system for construction and agricultural vehicles, wherein case (11) includes chamber (31) into which the blown air flows after passing through cooling heat exchanger (24) and first opening (33) and second opening (34) from which the blown air that has flowed into chamber (31) flows out, wherein first opening (33) is connected to first duct (51) bent and extended forward after extending rightward or leftward for ejecting the blown air toward the upper half part of the body of the occupant from the front of the occupant, wherein second opening (34) is connected to second duct (52) for ejecting the blown air toward the upper half of the body of the occupant from at least one of his/her rear and upper sides, wherein cooling heat exchanger (24) and chamber (31) are arranged in that order upward, and wherein first opening (33) is arranged rightward and/or leftward of case (11) while second opening (34) is arranged upward and/or forward of case (11).

According to this aspect, like in the second aspect, the air resistance of second duct (52) is lower than that of first duct (51), and therefore, a higher flow rate of the air ejected from the rear and/or upper sides of the occupant than the flow rate of the air ejected from the front side of the occupant can be secured easily. As a result, the occupant's sensation of being cooled can be improved without increasing the workload of blower (19).

Also, in the air conditioning system for construction and agricultural vehicles according to each aspect described above, case (11) may include an air capacity adjusting means (38) for adjusting the air capacity ratio between the blown air flowing out of first opening (33) and the blown air flowing out of second opening (34).

By doing so, the air capacity ratio between the blown air flowing out of first opening (33) and the blown air flowing out of second opening (34) can be easily adjusted. Specifically, the flow rate of the blown air flowing out of first opening (33) can be increased beyond the flow rate of the blown air flowing out of second opening (34) as required.

Also, in the air conditioning system for construction and agricultural vehicles according to each aspect described above, case (11) includes heating heat exchanger (25) for heating the blown air after passing through cooling heat exchanger (24) and a cool air bypass (27) for supplying cool air bypassing heating heat exchanger (25), and the chamber may be an air-mix chamber (31) for mixing the cool air passing through cool air bypass (27) and the warm air passing through heating heat exchanger (25).

Also, in the air conditioning system for construction and agricultural vehicles according to each aspect described above, case (11) includes a third opening (39) connected with a third duct (54) extending forward for ejecting the air toward a front windshield (4a) of a cabin (1), and third opening (39) may be arranged rightward, leftward, upward and/or forward of case (11). By doing so, fogging of front windshield (4a) can be prevented.

Incidentally, the reference numerals inserted in the parentheses following the names of the respective means described in this column and the scope of claims represent the correspondence with the specific means described in the embodiments below.

The present invention may be more fully understood from the description of preferred embodiments of the invention, as set forth below, together with the accompanying drawings.

### BRIEF DESCRIPTION OF THE DRAWINGS

FIG. 1 is a transparent perspective view schematically showing a cabin 1 of a hydraulic shovel according to a first embodiment of the invention.

FIG. 2 is a sectional view schematically showing cabin 1 of the hydraulic shovel according to the first embodiment.

FIG. 3 is a general front view of an air-conditioning unit 10 according to the first embodiment.

FIG. 4 is a view taken along arrow A in FIG. 3.

FIG. 5 is a sectional view taken along line B-B in FIG. 3.

FIG. 6 is a sectional view taken along line C-C in FIG. 3.

FIG. 7A is a front view showing a heat exchanger unit 13 of air-conditioning unit 10 according to a second embodiment.

FIG. 7B is a sectional view taken along line E-E in FIG. 7A.

FIG. 8 is a transparent perspective view schematically showing cabin 1 of the hydraulic shovel according to a third embodiment.

FIG. 9 is a general front view of air-conditioning unit 10 according to the third embodiment.

FIG. 10 is a view taken along arrow G in FIG. 9.

FIG. 11 is a sectional view taken along line H-H in FIG. 9.

FIG. 12 is a sectional view taken along line I-I in FIG. 9.

FIG. 13A is a plan view showing the heat exchanger unit of the conventional air-conditioning unit.

FIG. 13B is a sectional view taken along line X-X in FIG. 13A.

### DESCRIPTION OF THE PREFERRED EMBODIMENTS

### First Embodiment

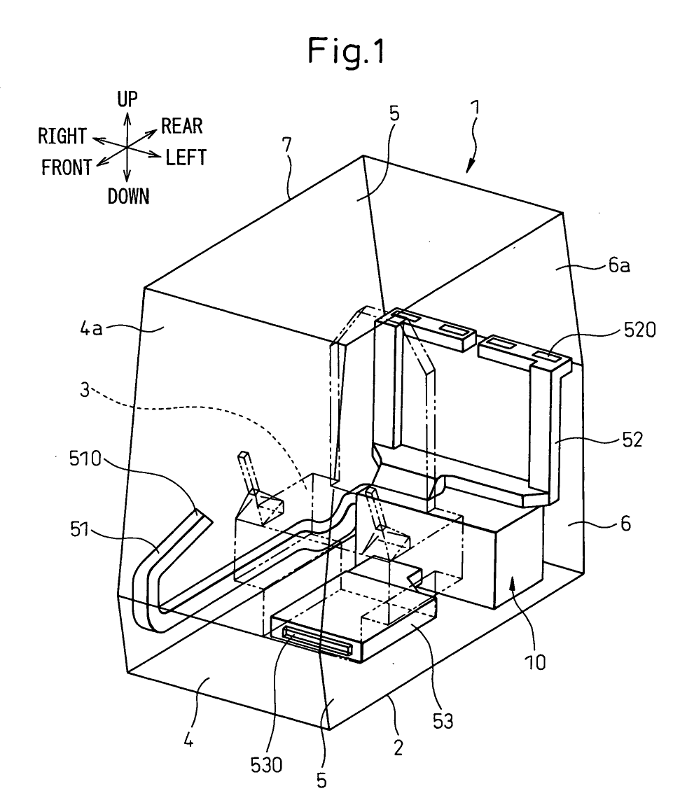

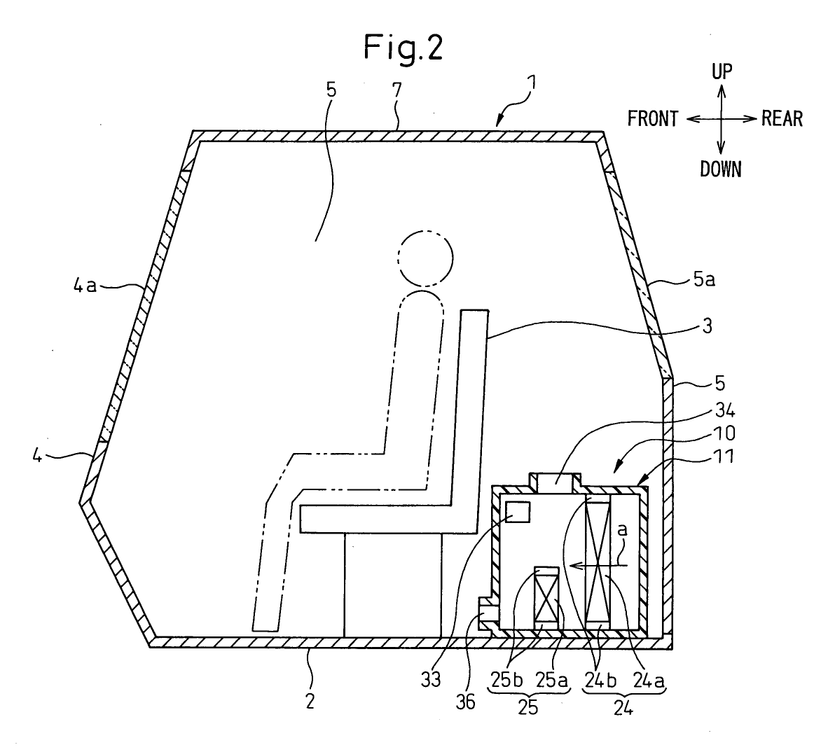

An example of the air conditioning system for construction and agricultural vehicles according to this invention in an application of a hydraulic shovel will be explained with reference to FIGS. 1 to 6. FIG. 1 is a transparent perspective view schematically showing cabin 1 of the hydraulic shovel according to this embodiment, and FIG. 2 a sectional view schematically showing cabin 1 of the hydraulic shovel according to this embodiment. In FIG. 2, the various ducts described later are not shown.

In FIG. 1, the two-dot chain line indicates a seat 3 installed at the substantial center on a floor 2 of cabin 1, and longitudinal, vertical and horizontal arrows shown indicate the longitudinal, vertical and horizontal directions, respectively, of cabin 1 as viewed from the occupant (see the two-dot chain line in FIG. 2) seated in seat 3. Further, each direction explained below is the direction as viewed from the occupant.

Cabin 1 of the hydraulic shovel includes a front wall portion 4 on the front side, side wall portions 5 on the left and right sides, a rear wall portion 6 on the rear side, a ceiling portion 7 and a floor portion 2, which define a cabin space. According to this embodiment, the upper part of front wall portion 4 comprises a front windshield 4a, and an upper part 6a of rear wall portion 6 comprises a rear glass window 5a. Also, at least one of the left and right side wall portions 5 has a door (not shown) used by the occupant to enter and leave the vehicle.

An air-conditioning unit 10 is mounted on the lower rear part of seat 3, i.e. on floor portion 2 behind seat 3. As a result, air-condition unit 10 assumes the shape of a thin box small in longitudinal thickness. Incidentally, the shape of air-conditioning unit 10 is shown in simple fashion for convenience of illustration.

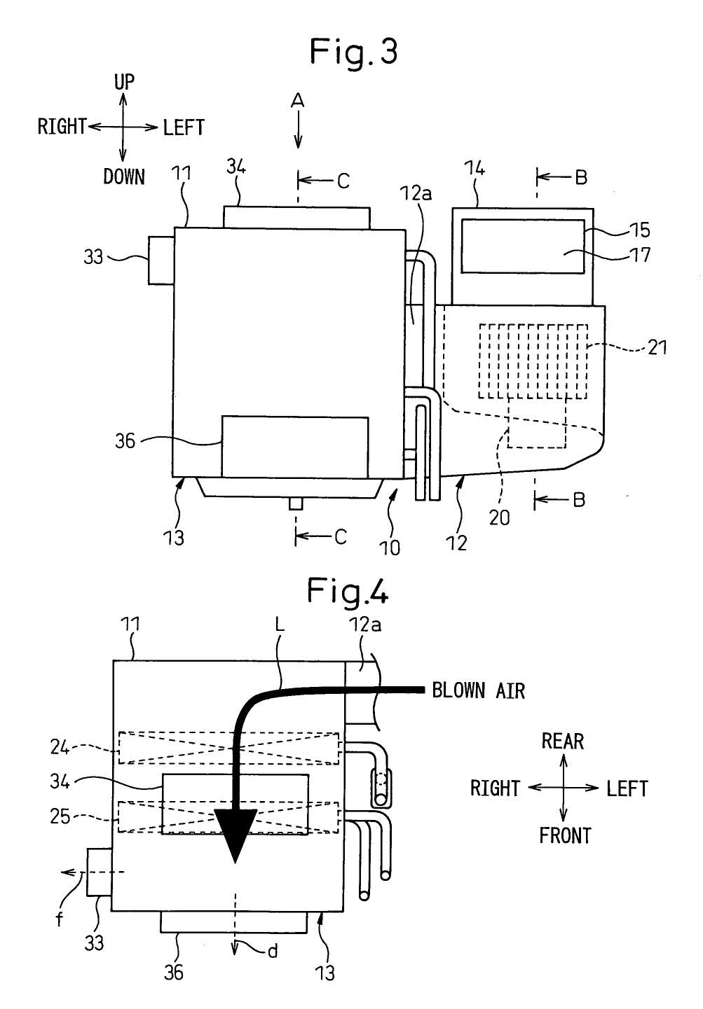

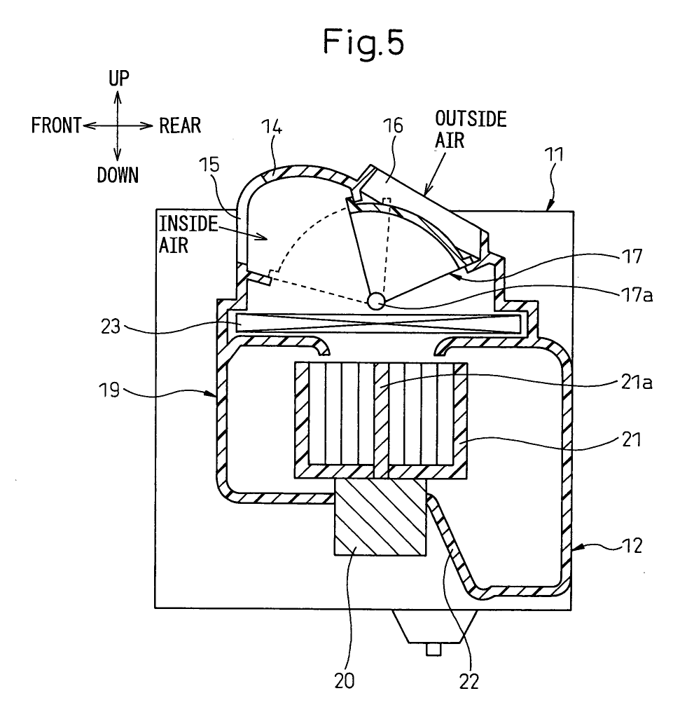

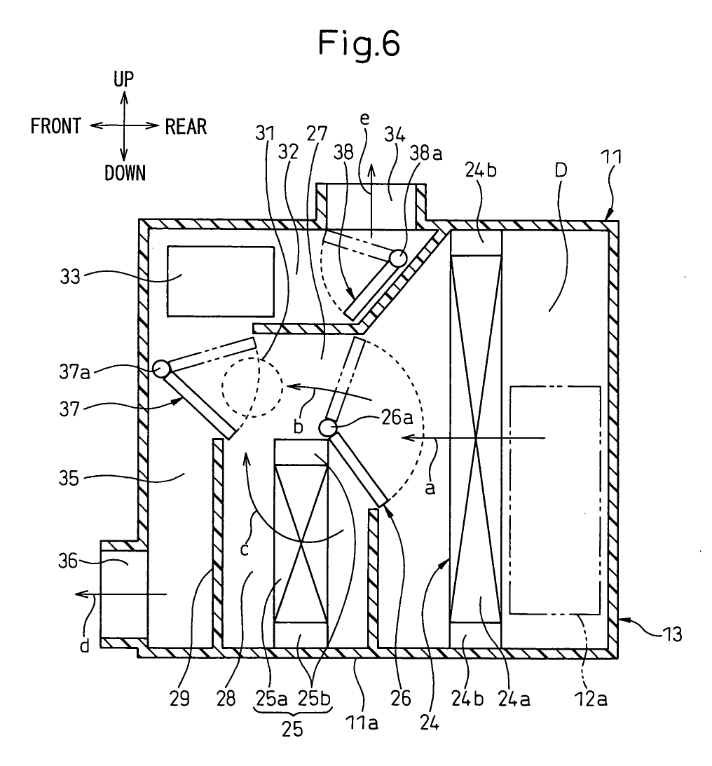

Next, a specific configuration of air-conditioning unit 10 will be explained. FIG. 3 is a general front view of air-conditioning unit 10 according to this embodiment, FIG. 4 a view taken along arrow A in FIG. 3, FIG. 5 a sectional view taken along line B-B in FIG. 3, and FIG. 6 a sectional view taken along line C-C in FIG. 3.

Air-conditioning unit 10 has case 11 in the shape of a thin box as described above, and an air path for the air blown into cabin 1 is formed in case 11. A blower unit 12 and a heat exchanger unit 13 are disposed in case 11.

Blower unit 12 is formed on the left side in case 11, and an inside-outside air switching box 14 is located on the upper left side of case 11 at the most upstream portion of the air path. An inside air introduction port 15 for introducing the inside air into the case is arranged on the front surface of inside-outside air switching box 14, and an outside air introduction port 16 for introducing the outside air into the case is arranged on the rear surface of box 14.

As a result, the inside air is introduced from the lower left side of seat 3, while the outside air is introduced from outside on the rear side of cabin 1 through a duct unit (not shown) for connecting outside air introduction port 16 and the exterior of cabin 1.

Also, an inside-outside switching door 17 for switching by opening/closing inside air introduction port 15 and outside air introduction port 16 is disposed in inside-outside air switching box 14. According to this embodiment, inside-outside air switching door 17 is composed of a rotary door. Inside-outside air switching door 17 is driven by an electric actuator (not shown) around a rotary shaft 17a extending horizontally.

Specifically, according to the position of rotation thereof, inside-outside air switching door 17 can be switched between the inside air mode for introducing the inside air from inside air introduction port 15, the outside air mode for introducing the outside air from outside air introduction port 16 and the inside/outside air mode for introducing the inside and outside air at the same time. In FIG. 5, the position of inside-outside air switching door 17 indicated by a solid line designates the inside air mode, and the position of inside-outside air switching door 17 indicated by a dashed line designates the outside mode.

An electrically-operated blower 19 for blowing the air into the cabin is arranged under inside-outside air switching box 14. Blower 19 comprises a centrifugal blow fan 21 rotationally driven by a motor 20 and a scroll casing 22 for accommodating blow fan 21.

Blow fan 21 is a centrifugal fan configured in an annular arrangement of blades having an arcuate section. Rotary shaft 21a of blow fan 21 is directed vertically, and blow fan 21 sucks in the air from inside-outside air switching box 14 above.

According to this embodiment, a filter 23 is inserted between inside-outside air switching box 14 and blower 19, which removes dust and dirt in the air flowing into blower 19.

Scroll casing 22 is arranged in a downwardly fanned-out fashion, so that the air blown by blow fan 21 is led from an air outlet 12a of blower unit 12 to the space (portion D in FIG. 6) on the rear side of cooling heat exchanger 24 of heat exchanger unit 13. The air blown by blow fan 21, therefore, flows in the direction toward heat exchanger unit 13 from blower unit 12 (left to right).

Next, heat exchanger unit 13 will be explained. Heat exchanger unit 13 is disposed on the right side of blower unit 12 in case 11. Cooling heat exchanger 24 is disposed rearward in heat exchanger unit 13, i.e. upstream of heat exchanger unit 13 in the air flow.

Cooling heat exchanger 24 is an evaporator in a refrigeration cycle, and has a heat exchange core unit 24a formed of tubes with a refrigerant passed therethrough and fins coupled to the outer surface of the tubes. The air blown from blower unit 12 is passed forward (along arrow a in FIG. 6) in the air gap of heat exchange core unit, and from this passing air, the low-temperature low-pressure refrigerant in the refrigeration cycle absorbs heat and is evaporated thereby to cool the air blown from blower unit 12.

Cooling heat exchanger 24 according to this embodiment has a tank unit 24b at each of the upper and lower ends thereof for distributing or collecting the refrigerant to and from a plurality of tubes.

Incidentally, a compressor (not shown) for circulating the refrigerant of the refrigeration cycle is driven by the engine (not shown) of the hydraulic shovel through an electromagnetic clutch. Also, cooling heat exchanger 24 assumes a substantially rectangular shape corresponding to the shape of substantially the whole area over the rear internal surface of heat exchanger unit 13 to allow the entire air flowing into the rear space (portion D in FIG. 6) of cooling heat exchanger 24 to pass through cooling heat exchanger 24.

A substantially rectangular cabin heating heat exchanger (heating heat exchanger) 25 is arranged downward and downstream of cabin cooling heat exchanger 24 in the air flow (front side of vehicle) in case 11. Cabin heating heat exchanger 25 is arranged over the whole width of case 11.

Cabin heating heat exchanger 25 is a hot-water type heat exchanger for heating the air with the cooling water (warm water) of the engine (not shown) of the hydraulic shovel as a heat source, and includes a heat exchange core unit 25a having a plurality of tubes allowing warm water to pass therethrough and fins coupled to the outer surface of the tubes. The air downstream of cooling heat exchanger 24 is passed and heated through the air gap of heat exchange core unit 25a.

Cabin heating heat exchanger 25 according to this embodiment is known as a total pass-type, which has a tank unit 25b at each of the upper and lower ends thereof for distributing or collecting warm water to and from a plurality of tubes, in which the lower tank portion makes up a warm water inlet tank portion.

Also, a tabular air-mix door 26 is arranged above cabin heating heat exchanger 25, and a rotary shaft 26a of air-mix door 26 is disposed in the neighborhood of the upper end portion of cabin heating heat exchanger 25.

Rotary shaft 26a of air-mix door 26 is arranged to extend in the direction perpendicular to the page (transversely of the vehicle) in FIG. 6, and the ends of rotary shaft 26a are held rotatably by bearing holes (not shown) on the left and right side walls of case 11. One end of rotary shaft 26a is projected out of case 11 and coupled to an electric actuator (not shown).

In case 11, a cool air bypass 27 for passing the cool air in the direction of arrow b bypassing cabin heating heat exchanger 25 is arranged above cabin heating heat exchanger 25 downstream of cabin cooling heat exchanger 24 in the air flow. In case 11, a warm air path 28 in which the warm air heated by cabin heating heat exchanger 25 flows along arrow c is formed downstream of cabin heating heat exchanger 25 in the air flow (on the front side of the vehicle).

Also, a warm air guide wall 29 projected upward is formed integrally with case 11 at a portion of the lower surface 11a of case 11 on the vehicle front side of cabin heating heat exchanger 25. This warm air guide wall 29 defines the vehicle front side of warm air path 28 and guides the warm air flow in warm air path 28 along arrow c toward cool air bypass 27.

As a result, an air-mix chamber 31 is adapted to mix the warm and cool air formed in the neighborhood of the forward end of warm air guide wall 29 above warm air path 28. Incidentally, air-mix chamber 31 corresponds to the chamber according to the invention.

In FIG. 6, the position of air-mix door 26 indicated by a solid line is the maximum cabin cooling position where the air path of cabin heating heat exchanger 25 is closed up while cool air bypass 27 is full open. The position of air-mix door 26 indicated by two-dot chain line, is the maximum cabin heating position for closing up cool air bypass 27 and fully opening the air path of cabin heating heat exchanger 25.

Air-mix door 26, is a temperature adjusting means for adjusting the temperature of the air ejected into the cabin by adjusting the air capacity ratio between the warm air (arrow c) passed through cabin heating heat exchanger 25 and the cool air (arrow b) passed through cool air bypass 27 bypassing cabin heating heat exchanger 25. In an air-mix chamber 31, the warm air (arrow c) and the cool air (arrow b) are mixed with each other to produce the air of the desired temperature.

In case 11, a face path 32 communicating with air-mix chamber 31 is formed above cool air bypass 27. This face path 32 is formed to extend from the front to the rear of the vehicle. A front face opening 33 is formed on the right side wall portion of face path 32 on the vehicle front side. Also, a rear face opening 34 is formed on the upper surface portion of face path 32 on the vehicle rear side. According to this embodiment, rear face opening 34 extends transversely of the vehicle. Incidentally, front face opening 33 corresponds to the first opening and rear face opening 34 to the second opening according to the invention.

Front face opening 33 is connected with a front face duct 51 (FIG. 1) extending toward the vehicle front, so that the air can be ejected toward the face of the occupant from his/her front by way of the downstream end portion of front face duct 51. Also, a defrosting air duct (not shown) is connected midway of front face duct 51, so that the air is ejected toward front windshield 4a from defrosting air outlet (not shown) at the downstream end of the defrosting air duct. Incidentally, front face duct 51 corresponds to the first duct according to the invention, and the defrosting air duct to the third duct according to the invention.

Front face air outlet 510 and the defrosting air outlet each have a shut mechanism not shown, whereby front face air outlet 510 and the defrosting air outlet are adapted to be opened/closed. This shut mechanism is opened/closed by manual operation of the occupant.

Rear face opening 34 is connected with a rear face duct 52 (FIG. 1) extending upward, so that the air is ejected toward the rear of the occupant from his/her rear side by way of rear face air outlet 520 at the downstream end of rear face duct 52. Incidentally, rear face duct 52 corresponds to the second duct according to the invention.

Also, a foot path 35 communicating with air-mix chamber 31 is formed on the vehicle front side of warm air path 28 in case 11. This foot path 35 is formed to extend downwardly.

A foot opening 36 is formed on the front wall under foot path 35. According to this embodiment, foot opening 36 extends transversely of the vehicle. Foot opening 36 is connected with a foot duct 53 (FIG. 1) extending toward the vehicle front, so that the air is ejected toward the feet of the occupant from a foot air outlet 530 at the downstream end of foot duct 53.

A tabular air outlet mode switching door 37 for opening/closing by switching face path 32 and foot path 35 is arranged on the vehicle front side of air-mix chamber 31. A rotary shaft 37a of air outlet mode switching door 37 is arranged to extend in the direction perpendicular to the page (transversely of the vehicle), and the ends of rotary shaft 37a are held rotatably by the bearing holes (not shown) on the left and right side walls of case 11. One end of rotary shaft 37a is projected outside of case 11 and coupled to an electrically-operated actuator (not shown).

In FIG. 6, the position of air outlet mode switching door 37 indicated by solid line represents the face mode in which foot path 35 is closed up while face path 32 is full open. The position of air outlet mode switching door 37 indicated by two-dot chain line, on the other hand, represents the foot mode in which face path 32 is closed up while foot path 35 is full open.

Also, a tabular rear face door 38 adapted to open/close rear face opening 34 is for adjusting the ratio between the ejection air capacity of front face air outlet 510 and the defrosting air outlet (not shown) and the ejection air capacity of rear face air outlet 520.

Rotary shaft 38a of rear face door 38 is arranged to extend in the direction perpendicular to the page (transversely of the vehicle), and the ends of rotary shaft 38a are rotatably held by the bearing holes (not shown) on the left and right side walls of case 11. An end of rotary shaft 38a is projected outside of case 11 and coupled to an electrically-operated actuator (not shown).

In FIG. 6, the position of rear face door 38 indicated by solid line is where rear face opening 34 is fully open. The position of rear face door 38 indicated by two-dot chain line, on the other hand, is where rear face opening 34 is closed up.

Though not shown, an air-conditioning operation panel is disposed on an instrument board arranged on the front of the internal space of the cabin, and includes a compressor operation switch for the refrigeration cycle, an air capacity switch, a temperature setting switch, an ejection air mode change-over switch, a longitudinal air capacity adjusting switch and an inside-outside air mode change-over switch.

Next, the operation of this embodiment will be explained. Upon turning on of the compressor operation switch on the air-conditioning operation panel, the electromagnetic clutch of the compressor in the refrigeration cycle is energized and connected so that the compressor is driven by the engine. As a result, the low-temperature low-pressure refrigerant in the refrigeration cycle is evaporated by absorbing heat from the air thereby to cool the air in cooling heat exchanger 24.

Upon turning on of an auto switch, the temperature of the air-conditioning air is adjusted and the ejection mode is switched automatically in accordance with the temperature set by a temperature setting switch. Incidentally, the adjustment of the temperature of the air-conditioning air and the switching of the ejection mode can be alternatively carried out manually.

The temperature of the air-conditioning air is adjusted, as described above, by operating air-mix door 26 and thus adjusting the mixing ratio between the cool air flowing through cool air bypass 27 and the warm air flowing through warm air path 28.

The air ejection mode includes the face mode selected at the time of cooling the cabin mainly in summer and the foot mode selected at the time of heating the cabin mainly in winter.

In the face mode used normally for cooling the cabin in the summer, air ejection mode switching door 37 is set in the position where face path 32 is fully open (the position indicated by the solid line) and rear face door 38 in the position where rear face opening 34 is fully open (the position indicated by solid line).

As a result, the air-conditioned air (cool air) is ejected toward the rear neighborhood of the occupant from rear face air outlet 520 through rear face duct 52, while at the same time being ejected toward the face of the occupant from front face air outlet 510 through front face duct 51.

In the case where it is desired to increase the amount of air ejected toward the face of the occupant as when the window is open, for example, rear face door 38 may be operated to a position where rear face opening 34 is closed.

Next, in the foot mode used for heating the cabin mainly in winter, air ejection mode switching door 37 is operated to the position where foot path 35 is full open (the position indicated by two-dot chain line).

As a result, the air-conditioning air (warm air) is ejected from foot air outlet 530 through foot opening 36 and foot duct 53.

As explained above, in the case where front face opening 33 connected with front face duct 52 extending forward is arranged on the right side of case 11, the air flow is required to be curved at least once in front face duct 51 to lead the air flowing out from the right side of case 11 to the front of the occupant. In the case where rear face opening 34 connected with rear face duct 52 extending upwardly is arranged on the upper surface of case 11, on the other hand, the air flow is not required to be curved in rear face duct 52.

Thus, the air resistance of rear face duct 52 is decreased below that of front face duct 51, and therefore, a higher flow rate of the air ejected from the rear face air outlet can be easily secured than the flow rate of the air ejected from front face air outlet. As a result, the occupant's sensation of being cooled can be improved without increasing the workload of blower 19.

According to this embodiment, as indicated by arrow L in FIG. 4, the air flowing in from blower unit 12 changes its direction by 90° on the vehicle rear side in cooling heat exchanger 24 of heat exchanger unit 13. Specifically, the blown air, after flowing toward the right side of the vehicle from the left side thereof, flows in the direction forward of the vehicle from the vehicle rear side.

As indicated by arrow a in FIG. 6, the air passing through cooling heat exchanger 24 flows in the direction forward of the vehicle from the rear side thereof. Then, as indicated by arrow b in FIG. 6, the air flowing into air-mix chamber 31 flows toward the vehicle front side from the vehicle rear side.

As indicated by arrow e in FIG. 6, the air passing through rear face opening 34 flows upward. Also, as indicated by arrow f in FIG. 4, the air passing through front face opening 33 flows from left to right side of the vehicle.

As a result, the first angle θ1 is 90° between the first outflow direction (arrow f) of the air flowing out from front face opening 33 and the inflow direction (arrow b) in which the air flows into air-mix chamber 31. Further, the second angle θ2 is 90° between the second outflow direction (arrow e) in which the air flows out from rear face opening 34 and the inflow direction (arrow b) in which the air flows into air-mix chamber 31. In this way, both the first angle θ1 and the second angle θ2 are 90°.

The smaller the angle between the inflow direction in which the blown air flows into air-mix chamber 31 and the direction in which the blown air flows out of the openings, the higher the flow rate at which the blown air flows out from the openings.

For this reason, by equalizing the first angle θ1 and the second angle θ2 as in this embodiment, the flow rate of the blown air flowing out from rear face opening 34 can be easily rendered equal to the flow rate of the blown air flowing out from front face opening 33. In other words, the flow rate of the air ejected from the rear of the occupant can be easily rendered equal to the flow rate of the air ejected from the front of the occupant. As a result, the occupant's sensation of being cooled can be improved without increasing the workload of blower 19.

Also, the provision of rear face door 38 in case 11 facilitates the adjustment of the air capacity ratio between the blown air flowing out from front face opening 33 and the blown air flowing out from rear face opening 34. In other words, the flow rate of the blown air flowing out from front face opening 33 can be increased beyond the flow rate of the blown air flowing out from rear face opening 34 as required.

Also, according to this embodiment, as indicated by arrow d in FIGS. 4 and 6, the air passing through foot opening 36 also flows forward from the rear side of the vehicle. Specifically, the direction in which the air flows in foot opening 36 coincides with the direction in which the air flows into air-mix chamber 31. As a result, the capacity of the air flowing in foot opening 36 can be easily secured and so can the capacity of the air ejected out of foot air outlet 530.

Also, according to this embodiment, as understood from FIG. 4, air outlet 12a of blower unit 12 can be arranged at the tail of air-conditioning unit 10, and therefore, air outlet 12a of blower unit 12 can be arranged at a distance from the occupant, and thus, noise of the blower can be reduced.

Also, according to this embodiment, a substantially rectangular cabin cooling heat exchanger 24 is arranged substantially vertically in case 11, and therefore, the body of air-conditioning unit 10 along vehicle length can be reduced in size. As a result, the space in the vehicle cabin available for use by the occupant can be increased.

### Second Embodiment

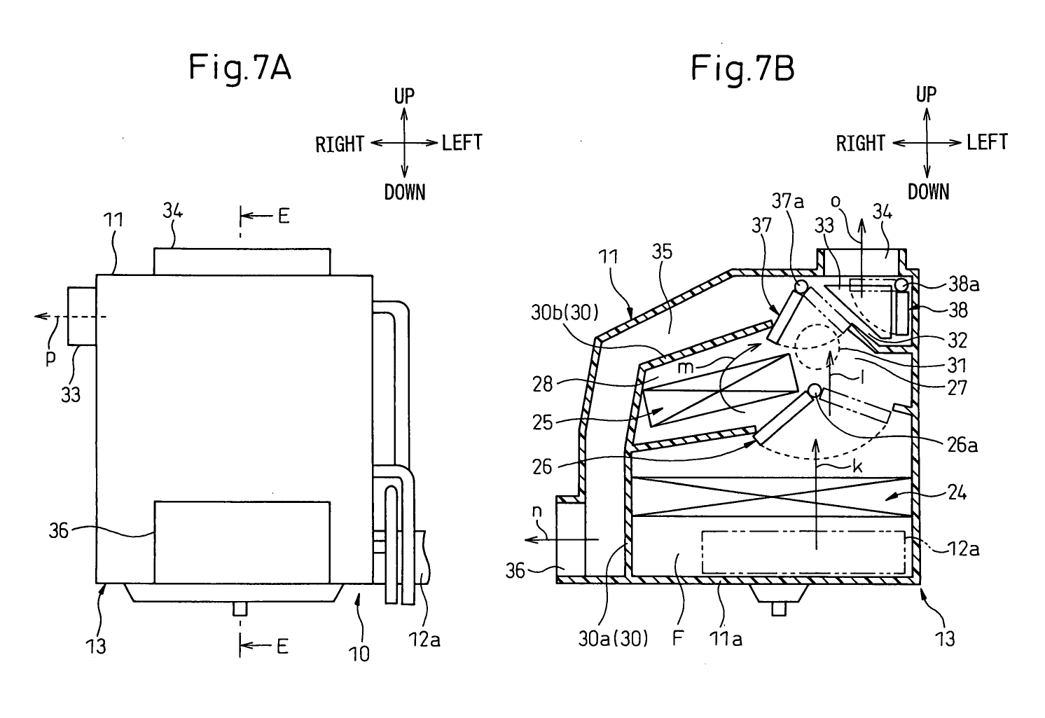

Next, a second embodiment of the invention will be explained with reference to FIGS. 7A and 7B. The component parts similar to those of the first embodiment described above are designated by the same reference numerals, respectively, and will not be described again.

FIG. 7A is a front view showing a heat exchanger unit 13 of an air-conditioning unit 10 according to the second embodiment, and FIG. 7B a sectional view taken along line E-E in FIG. 7A. As shown in FIGS. 7A and 7B, air-conditioning unit 10 according to this embodiment is arranged in such a manner that the air blown by a blow fan (not shown) is led from an air outlet 12a of a blower unit (not shown) to the space under cabin cooling heat exchanger 24 of heat exchanger unit 13 (the portion F in FIG. 7B). The air blown by the blow fan, therefore, flows in the direction toward heat exchanger unit 13 (from left to right) from the blower unit.

Heat exchanger unit 13 is arranged on the right side of the blower unit in a case 11. Cabin cooling heat exchanger 24 is disposed in the internal lower part of heat exchanger unit 13, i.e. on the upstream side of heat exchanger unit 13 in the air flow. The air blown from the blower unit is passed upward (along arrow k in FIG. 7B) through the gap of the heat exchange core unit.

Next, in case 11, a cabin heating heat exchanger 25 is arranged on the downstream side (upper side) of cabin cooling heat exchanger 24 on the vehicle front side. Also, a tabular air-mix door 26 is arranged on the vehicle rear side of cabin heating heat exchanger 25, and a rotary shaft 26a of air-mix door 26 is disposed in the neighborhood of heating heat exchanger 25 at the vehicle rear end.

In case 11, a cool air bypass 27 in which cool air bypassing cabin heating heat exchanger 25 flows along arrow 1 is arranged on the downstream side of cabin cooling heat exchanger 24 on the vehicle rear side of cabin heating heat exchanger 25. In case 11, on the other hand, a warm air path 28 in which the warm air heated by cabin heating heat exchanger 25 flows along the direction of arrow m is formed on the downstream side (upper side) of cabin heating heat exchanger 25 in the air flow.

Also, a guide wall 30, which bent rearward of the vehicle after being projected upwardly, is formed integrally with case 11 on the portion of lower surface 11a of case 11 on the vehicle front side of cabin cooling heat exchanger 24 and cabin heating heat exchanger 25. Specifically, guide wall 30 comprises a first portion 30a extending substantially vertically and a second portion 30b extending substantially longitudinally of the vehicle.

Second portion 30b is for defining the upper side of warm air path 28, and guides the warm air in warm air path 28 toward cool air bypass 27 along the direction of arrow m. As a result, air-mix chamber 31 capable of mixing the warm air and the cool air is satisfactorily formed around the forward end of second portion 30b in warm air path 28 on the vehicle rear side.

In FIG. 7B, the position of air-mix door 26 indicated by a solid line represents the maximum cabin cooling position where the air path of cabin heating heat exchanger 25 is closed up and cool air bypass 27 is full open, while the position indicated by a two-dot chain line represents the maximum heating position where cool air bypass 27 is closed up and the air path of cabin heating heat exchanger 25 is full open.

In case 11, a face path 32 communicating with air-mix chamber 31 is formed above cool air bypass 27. A front face opening 33 is formed on the right side wall of face path 32. Also, a rear face opening 34 is formed on the upper surface of face path 32.

Also, a foot path 35 communicating with air mix chamber 31 is formed above warm air path 28 on the vehicle front side thereof in case 11, i.e. on the side of guide wall 30 far from warm air path 28, cabin heating heat exchanger 25 and cabin cooling heat exchanger 24. This foot path 35 is formed, after extending forward, to extend downwardly. A foot opening 36 is formed on the front wall portion in the lower part of foot path 35.

A tabular air outlet mode switching door 37 is arranged above air-mix chamber 31 to switch the open/close state of face path 32 and foot path 35. A rotary shaft 37a of air outlet mode switching door 37 is arranged to extend in the direction perpendicular to the page (transversely of the vehicle) in FIG. 7B.

In FIG. 7B, the position of air outlet mode switching door 37 indicated by solid line represents the face mode in which foot path 35 is closed up and face path 32 full open. The position of air outlet mode switching door 37 indicated by two-dot chain line, on the other hand, represents the foot mode in which face path 32 is closed up and foot path 35 full open.

Also, a tabular rear face door 38 adapted to open/close rear face opening 34 is for adjusting the ratio between the capacity of the air ejected from front face air outlet (not shown) and the defrosting air outlet (not shown) on the one hand and the capacity of the air ejected from rear face air outlet (not shown) on the other hand. A rotary shaft 38a of rear face door 38 is arranged to extend in the direction perpendicular to the page (transversely of the vehicle) in FIG. 7B.

In FIG. 7B, the position of rear face door 38 indicated by a solid line is where rear face opening 34 is full open, while the position of rear face door 38 indicated by two-dot chain line is where rear face opening 34 is closed up.

As explained above, in the case where front face opening 33 connected with a front face duct 51 extending forward is arranged on the right side of case 11, the air flow is required to be curved at least once in front face duct 51 in order to lead the air flowing out from the right side of case 11 to the front of the occupant. In the case where rear face opening 34 connected with a rear face duct 52 extending upwardly is arranged on the upper surface of case 11, on the other hand, the air flow is not required to be curved in rear face duct 52.

For this reason, the air resistance of rear face duct 52 is reduced below that of front face duct 51, and therefore, the flow rate of the air ejected from the rear face air outlet can be easily rendered higher than that of the air ejected from the front face air outlet. As a result, the occupant's sensation of being cooled can be improved without increasing the workload of blower 19.

According to this embodiment, the air that has flowed in from the blower unit changes its direction by 90° in the lower part of cabin cooling heat exchanger 24 of heat exchanger unit 13. In other words, the blown air flows upward after flowing rightward from left to right side of the vehicle.

As a result, as shown by arrow k in FIG. 7B, the air passed through cabin cooling heat exchanger 24 flows upward. Then, as shown by arrow 1 in FIG. 7B, the air entering air-mix chamber 31 flows upward.

As shown by arrow o in FIG. 7B, on the other hand, the air flows upward through rear face opening 34. Also, as shown by arrow p in FIG. 7A, the air flows through front face opening 33 in the direction from left to right side of the vehicle.

Therefore, the first angle θ1 between the first outflow direction (arrow p) in which the air flows out of front face opening 33 and the inflow direction (arrow 1) in which the air flows into air-mix chamber 31 is 90°. On the other hand, the second outflow direction (arrow o) in which the air flows out from rear face opening 34 and the inflow direction (arrow 1) in which the air flows into air-mix chamber 31 coincide with each other. Specifically, the second angle θ2 between the second outflow direction in which the air flows out from rear face opening 34 and the inflow direction in which the air flows into air-mix chamber 31 is 0°. As a result, the first angle θ1 is larger than the second angle θ2.

Therefore, the flow rate of the blown air flowing out from rear face opening 34 is easily rendered larger than the flow rate of the blown air flowing out from front face opening 33. Specifically, the flow rate of the air ejected from the rear side of the occupant can be easily increased beyond the flow rate of the air ejected from the front side of the occupant. As a result, the occupant's sensation of being cooled can be improved without increasing the workload of blower 19.

### Third Embodiment

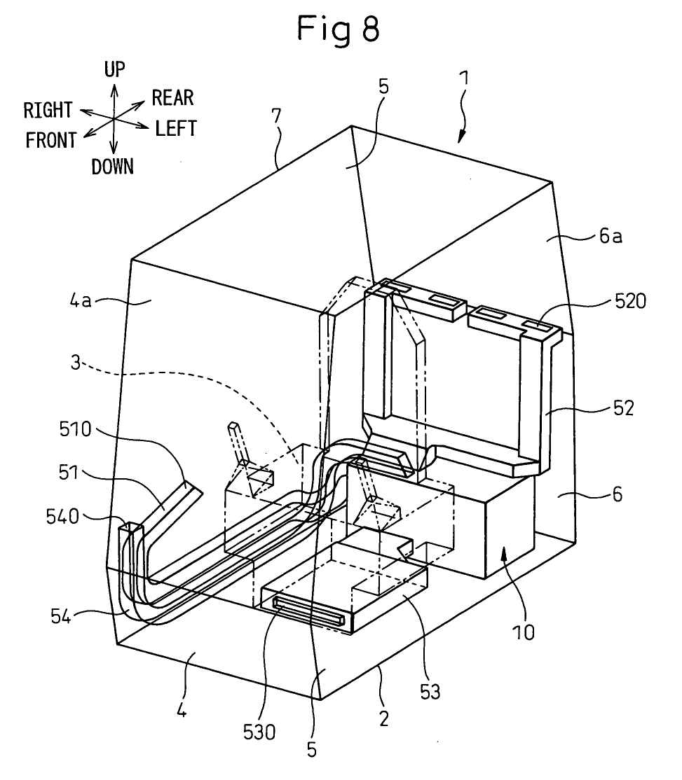

Next, a third embodiment of the invention will be explained with reference to FIGS. 8 to 12. The component parts similar to those of the first embodiment are designated by the same reference numerals and will not be explained again.

FIG. 8 is a transparent perspective view schematically showing a cabin 1 of a hydraulic shovel according to the third embodiment. As shown in FIG. 8, cabin 1 of the hydraulic shovel has a defrosting air duct 54 for ejecting the air toward a front windshield 4a from a defrosting air outlet 540.

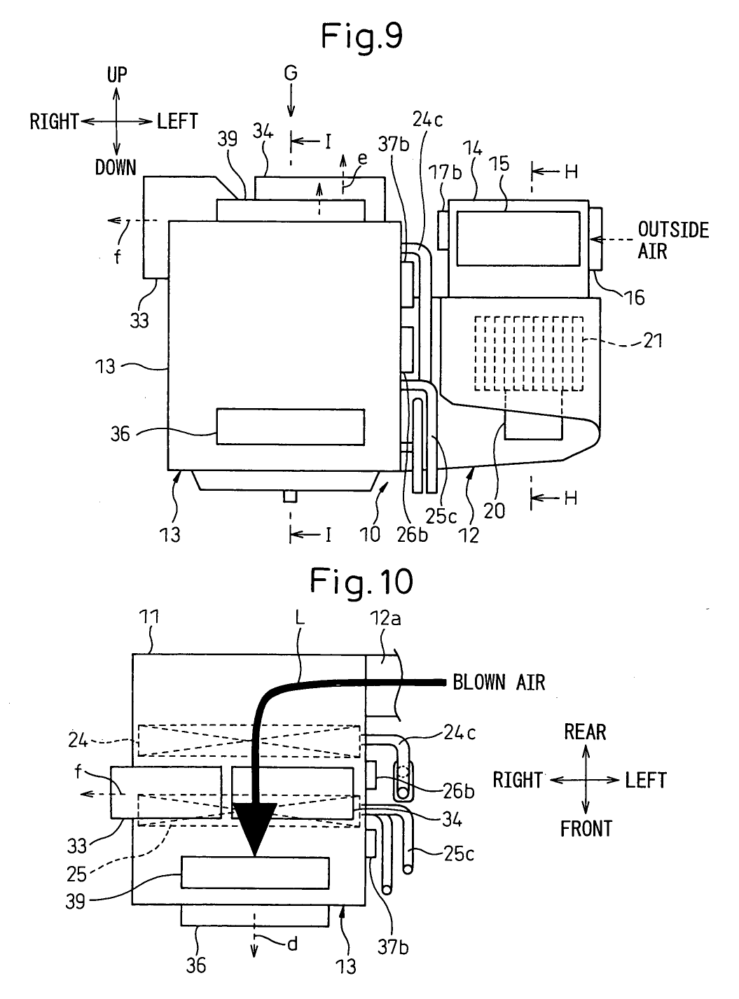

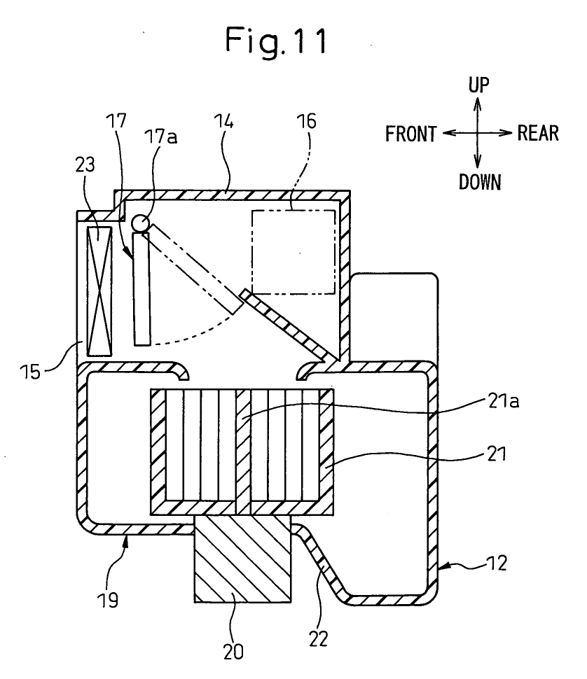

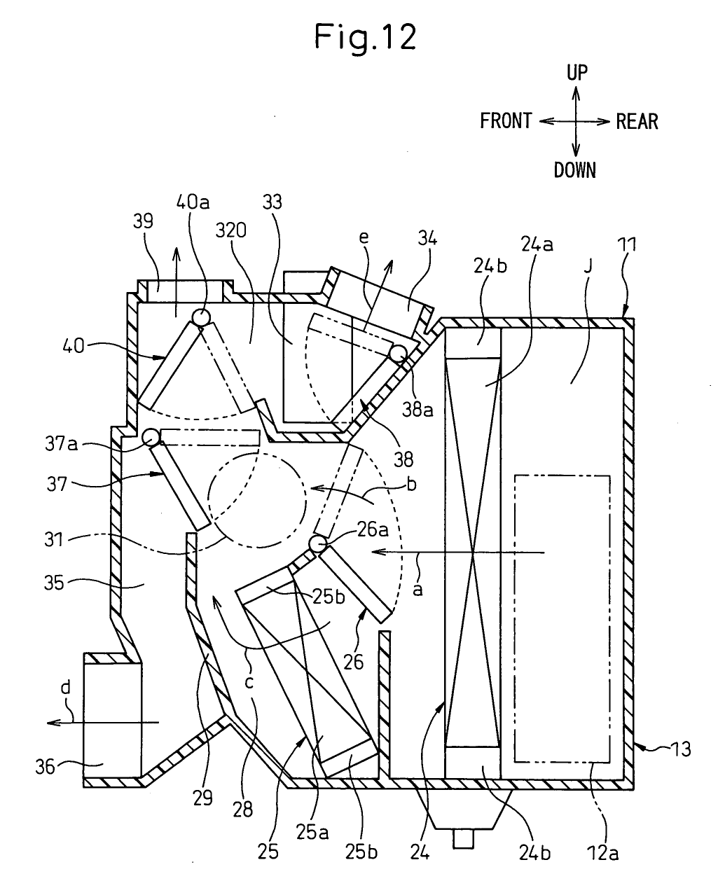

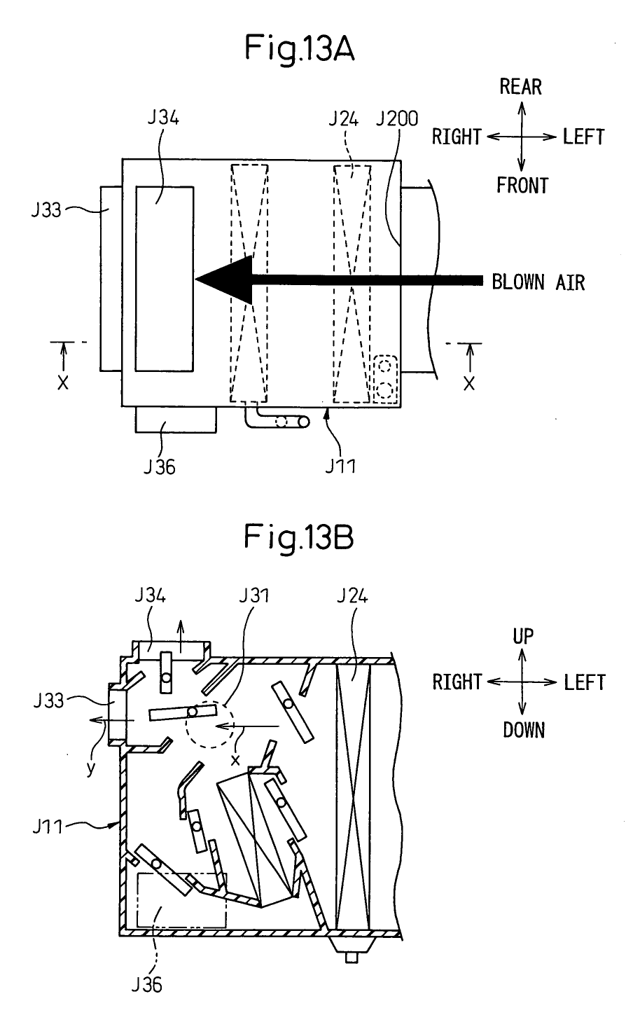

FIG. 9 is a front view showing a general configuration of an air-conditioning unit 10 according to the third embodiment. FIG. 10 is a view taken along arrow G in FIG. 9, FIG. 11 a sectional view taken along line H-H in FIG. 9 and FIG. 12 a sectional view taken along line I-I in FIG. 9. As shown in FIGS. 9 to 12, an outside air introduction port 16 according to this embodiment is arranged on the left surface of inside-outside air switching box 14. The outside air, therefore, is introduced from the left external side of cabin 1 through a duct portion (not shown) connecting outside air introduction port 16 and the exterior of cabin 1.

Also, a tabular inside-outside air switching door 17 is disposed in inside-outside air switching box 14. Inside-outside air switching door 17 is driven by a servo motor 17b around a rotary shaft 17a extending horizontally. According to this embodiment, servo motor 17b is assembled on the external right side of inside-outside air switching box 14. In FIG. 11, the position of inside-outside switching door 17 indicated by solid line shows the outside air mode, and the position of inside-outside switching door 17 indicated by a two-dot chain line the inside air mode.

Also, according to this embodiment, a filter 23 is arranged immediately downstream of an inside air introduction port 15.

Air-conditioning unit 10 according to this embodiment is arranged so that the air blown by blow fan 21 is led to the space (portion J in FIG. 12) behind cabin cooling heat exchanger 24 of heat exchanger unit 13 from an air outlet 12a of blower unit 12. The air blown by blow fan 21, therefore, flows in the direction toward heat exchanger unit 13 (rightward) from blower unit 12.

A rotary shaft 26a of an air-mix door 26 is arranged to extend in the direction perpendicular to the page (transversely of the vehicle) in FIG. 12, and the ends of rotary shaft 26a are held rotatably by bearing holes (not shown) on the left and right side walls of case 11. According to this embodiment, the left end of rotary shaft 26a is projected out of case 11 and coupled to a servo motor 26b (FIGS. 9 and 10). Servo motor 26b is assembled on the left side exterior of case 11.

As shown in FIG. 12, a face defrosting air path 320 communicating with an air-mix chamber 31 is formed above a cool air bypass 27 in case 11. This face defrosting air path 320 is formed to extend in the direction rearward of the vehicle. A defrosting air opening 39 is formed on the upper surface of face defrosting air path 320 on the vehicle front side. Also, a front face opening 33 is formed on the right side wall of face defrosting air path 320 on the vehicle rear side. Further, rear face opening 34 is formed on the upper surface of face defrosting air path 320 on the vehicle rear side.

A defrosting air opening 39 is connected to a defrosting air duct 54 (FIG. 8) extending toward the vehicle front, so that the air is ejected toward a front windshield 4a from a defrosting air outlet 540 at the downstream end of the defrosting air duct 54. As a result, the fogging of front windshield 4a can be prevented. Incidentally, defrosting air opening 39 corresponds to the third opening according to the invention.

A rotary shaft 37a of an air outlet mode switching door 37 is arranged to extend in the direction perpendicular to the page (transversely of the vehicle) in FIG. 12, and the ends of rotary shaft 37a are held rotatably in the bearing holes (not shown) on the left and right walls of case 11. According to this embodiment, the left end of rotary shaft 37a is projected out of case 11 and coupled to a servo motor 37b (FIGS. 9 and 10). This servo motor 37b is assembled on the left side exterior of case 11.

Also, a tabular rear face door 38 adapted to open/close rear face opening 34 is for adjusting the ratio between the ejection air capacity from a front face air outlet 510 and the ejection air capacity from a rear face air outlet 520.

A rotary shaft 38a of rear face door 38 is arranged to extend in the direction perpendicular to the page (transversely of the vehicle), and rotatably held by the bearing holes (not shown) on the left and right side walls of case 11. The left end of rotary shaft 38a is projected out of case 11 and coupled to a servo motor (not shown). This servo motor is assembled on the left side exterior of case 11.

In FIG. 12, the position of rear face door 38 indicated by solid line represents a position where rear face opening 34 is full open, while the position of rear face door 38 indicated by two-dot chain line is where rear face opening 34 is closed up.

Also, a tabular defrosting air door 40 adapted to open/close defrosting air opening 39 is for adjusting the capacity of the air ejected from defrosting air outlet 540 (FIG. 8). Further, a rotary shaft 40a of defrosting air door 40 is arranged to extend in the direction perpendicular to the page (transversely of the vehicle) and the ends of rotary shaft 40a are rotatably held by the bearing holes (not shown) on the left and right side walls of case 11. According to this embodiment, the left end of rotary shaft 40a is projected out of case 11 and coupled to a servo motor (not shown). This servo motor is assembled on the left side exterior of case 11.

In FIG. 12, the position of defrosting air door 40 indicated by a solid line is where defrosting air opening 39 is closed up. The position of defrosting air door 40 indicated by two-dot chain line, on the other hand, is where defrosting air opening 39 is full open.

Also, as shown in FIGS. 9 and 10, a refrigerant pipe 24c making up a path to circulate the refrigerant to cabin cooling heat exchanger 24 and a warm water pipe 25c making up a path to circulate the warm water to cabin heating heat exchanger 25 are connected to the left side exterior of case 11. Also, though not shown, various sensors including an ejection air temperature sensor for detecting the temperature of the air immediately after passing through cabin cooling heat exchanger 24 is assembled on the left side exterior of case 11.

As explained above, in the case where front face opening 33 connected with front face duct 51 extending forward is arranged on the right side of case 11, the air flow is required to be curved at least once in front face duct 51 to lead the air flowing out of the right side of case 11 to the front of the occupant. In the case where rear face opening 34 connected with rear face duct 52 extending upwardly is arranged on the upper surface of case 11, on the other hand, the air flow is not required to be curved in rear face duct 52.

As a result, the air resistance of rear face duct 52 is reduced below the air resistance of front face duct 51, and therefore, the flow rate of the air ejected from the rear face air outlet is easily rendered higher than the flow rate of the air ejected from the front face air outlet. Thus, the occupant's sensation of being cooled can be improved without increasing the work done by blower 19.

Also, according to this embodiment, a refrigerant pipe 24c, a warm water pipe 25c, servo motors 17b, 26b, 37b and various sensors can be arranged between blower unit 12 and heat exchanger unit 13. Therefore, the directions of assemblage can be unified and the number of assembling time reduced. Also, electrical parts (servo motors 17b, 26b, 37b and various sensors) can be arranged concentrated between blower unit 12 and heat exchanger unit 13, and therefore, the harnesses connected to the electrical parts can be shortened. Further, maintenance work can be done since the parts including various sensors are arranged concentrated between blower unit 12 and heat exchanger unit 13.

### Other Embodiments

In the aforementioned embodiments, an electrical actuator (not shown) including a servo motor is used as a drive mechanism for rotationally driving inside-outside switching door 17, air-mix door 26, air ejection mode switching door 37 and rear face door 38. Alternatively, a manual operating mechanism for transferring the manual operating force of the operating member (such as a manual operating lever) arranged on an air-conditioning operation panel (not shown) to each rotary shaft 17a, 26a, 37a, 38a through a cable, a link mechanism or the like, may be used as a drive mechanism for doors 17, 26, 37, 38.

Also, in each of the aforementioned embodiments, an example is explained in which the air is ejected toward the rear neighborhood of the occupant from behind him/her from rear face air outlet 520. Nevertheless, the invention is not limited to this configuration, and the air may be ejected toward the rear neighborhood of the occupant from above him/her or from both behind and above him/her.

Also, in each of the aforementioned embodiments, an example is explained in which front face opening 33 is formed on the right side wall of face path 32. Nevertheless, the invention is not limited to this configuration, and front face opening 33 may be formed on the left side wall or both the left and right side walls.

In a similar fashion, in each of the aforementioned embodiments, an example is explained in which rear face opening 34 is formed on the upper surface of face path 32. Nevertheless, the invention is not limited to this configuration, and rear face opening 34 may be formed on the front surface or on both the upper and front surfaces.

Also, in each of the aforementioned embodiments, air-conditioning unit 10 is mounted on the tail or the lowest portion in the cabin space. Nevertheless, air-conditioning unit 10 may be mounted in any of other positions such as at the central portion on the bottom of the cabin space, i.e. under seat 3.

Also, in each of the aforementioned embodiments, an example is explained in which the outside air is introduced from the rear exterior of cabin 1. Nevertheless, the invention is not limited to such a configuration, and the outside air may be introduced from the left side exterior.

Also, in each of the aforementioned embodiments, an example is explained in which the air-conditioning operation panel is disposed in the front part of the internal space of the cabin. Nevertheless, the air-conditioning operation panel may alternatively be arranged on the right side surface.

Also, in each of the aforementioned embodiments, cabin cooling heat exchanger 24 and cabin heating heat exchanger 25 are used as heat exchangers for exchanging heat with the air. Nevertheless, cabin heating heat exchanger 25 may be done without and only cabin cooling heat exchanger 24 may be used.

Also, in each of the aforementioned embodiments, an example is explained in which the vehicle air conditioning system according to the invention is used for a construction vehicle such as the hydraulic shovel. Nevertheless, the application of this invention is not limited to the construction vehicle such as the hydraulic shovel, but the invention is also applicable to other various vehicles such as an agricultural tractor.

Also, in the third embodiment described above, an example is explained in which defrosting air opening 39 is formed on the upper surface of face defrosting air path 320. Nevertheless, the invention is not limited to this configuration, and defrosting air opening 39 may be formed on any one of the right side wall, the left side wall and the front surface or two or more of the upper surface, the right side wall, the left side wall and the front surface with equal effect.

While the invention has been described by reference to specific embodiments chosen for purposes of illustration, it should be apparent that numerous modifications could be made thereto by those skilled in the art without departing from the basic concept and scope of the invention.

1. An air conditioning system for construction and agricultural vehicles, comprising:
a blower for blowing the air into a cabin;
a case through which the air blown by the blower flows; and
a cooling heat exchanger for cooling the blown air;
wherein the case includes a chamber into which the blown air flows after passing through the cooling heat exchanger, and a first opening and a second opening from which the blown air that has flowed into the chamber flows out,
wherein the first opening causes the air blown out toward the upper half part of the body of the occupant from the front of the occupant to flow out from the chamber,
wherein the second opening causes the air blown out toward the upper half part of the body of the occupant from at least one of the rear side and the upper side of the occupant to flow out from the chamber, and
wherein the first opening and the second opening are arranged in such a manner that a first angle between the inflow direction in which the blown air flows into the chamber and the first outflow direction in which the blown air flows out from the first opening is not less than a second angle between the inflow direction and the second outflow direction in which the blown air flows out from the second opening to make sure that the flow rate of the blown air flowing out from the second opening is higher than the flow rate of the blown air flowing out from the first opening.

2. The air conditioning system for construction and agricultural vehicles according to claim 1, wherein the first angle and the second angle are equal to each other.

3. The air conditioning system for construction and agricultural vehicles according to claim 2, wherein the first angle and the second angle are both 90°.

4. The air conditioning system for construction and agricultural vehicles according to claim 1,
wherein the cooling heat exchanger and the chamber are arranged in that order in the direction forward of the vehicle,
wherein the inflow direction is forward,
wherein the first outflow direction is rightward and/or leftward from the chamber, and
wherein the second outflow direction is upward and/or forward from the chamber.

5. The air conditioning system for construction and agricultural vehicles according to claim 1,
wherein the cooling heat exchanger and the chamber are arranged in that order in the upward direction,
wherein the inflow direction is upward,
wherein the first outflow direction is rightward and/or leftward from the chamber, and
wherein the second outflow direction is upward and/or forward from the chamber.

6. The air conditioning system for construction and agricultural vehicles according to claim 1,
wherein the case includes an air capacity adjusting means for adjusting the air capacity ratio between the blown air flowing out from the first opening and the blown air flowing out from the second opening.

7. The air conditioning system for construction and agricultural vehicles according to claim 1,
wherein the case includes a heating heat exchanger for heating the blown air after being passed through the cooling heat exchanger and a cool air bypass in which the cool air flows bypassing the heating heat exchanger, and
wherein the chamber is an air-mix chamber for mixing the cool air passing through the cool air bypass and the warm air passing through the heating heat exchanger.

8. An air conditioning system for construction and agricultural vehicles, comprising:
a blower for blowing the air into a cabin;
a case in which the air blown by the blower flows; and
a cooling heat exchanger for cooling the blown air;
wherein the case includes a chamber into which the blown air flows after passing through the cooling heat exchanger and a first opening and a second opening from which the blown air that has flowed into the chamber flows out,
wherein the first opening is connected with a first duct bent and extended forward after extending rightward or leftward for ejecting the blown air toward the upper half part of the body of the occupant from the front side of the occupant,
wherein the second opening is connected with a second duct extending upward for ejecting the blown air toward the upper half part of the body of the occupant from at least one of the rear side and the upper side of the occupant,
wherein the cooling heat exchanger and the chamber are arranged in that order in the direction forward of the vehicle,
wherein the first opening is arranged rightward and/or leftward of the case, and
wherein the second opening is arranged upward and/or forward of the case.

9. An air conditioning system for construction and agricultural vehicles, comprising:
a blower for blowing the air into a cabin;
a case in which the air blown by the blower flows; and
a cooling heat exchanger for cooling the blown air;
wherein the case includes a chamber into which the blown air flows after passing through the cooling heat exchanger and a first opening and a second opening through which the blown air that has flows into the chamber flows out,
wherein the first opening is connected to a first duct bent and extended forward after extending rightward or leftward for ejecting the blown air toward the upper half part of the body of the occupant from the front side of the occupant,
wherein the second opening is connected with a second duct extending upward for ejecting the blown air toward the upper half part of the body of the occupant from at least one of the rear side and the upper side of the occupant,
wherein the cooling heat exchanger and the chamber are arranged in that order in the upward direction,
wherein the first opening is arranged rightward and/or leftward of the case, and
wherein the second opening is arranged upward and/or forward of the case.

10. The air conditioning system for construction and agricultural vehicles according to claim 8,
wherein the case includes an air capacity adjusting means for adjusting the air capacity ratio between the blown air flowing out of the first opening and the blown air flowing out of the second opening.

11. The air conditioning system for construction and agricultural vehicles according to claim 8,
wherein the case includes a heating heat exchanger for heating the blown air after passing through the cooling heat exchanger and a cool air bypass in which the cool air flows bypassing the heating heat exchanger, and
wherein the chamber is an air-mix chamber for mixing the cool air passing through the cool air bypass and the warm air passing through the heating heat exchanger.

12. The air conditioning system for construction and agricultural vehicles according to claim 8,
wherein the case includes a third opening connected with a third duct extending forward for ejecting the air toward the front windshield of the cabin, and
wherein the third opening is arranged rightward, leftward, upward and/or forward of the case.
